(19) United States
(12) Patent Application Publication
(10) Pub. No.: US 2016/0021417 A1
(43) Pub. Date: Jan. 21, 2016

(54) INTERACTIVE SYSTEM AND METHOD FOR INTELLIGENT TELEVISION

(71) Applicant: SHENZHEN COOCAA NETWORK TECHNOLOGY CO,.LTD, Guangdong (CN)

(72) Inventors: Zhiguo Wang, Shenzhen (CN); Xianhui Zeng, Shenzhen (CN); Jia Liu, Shenzhen (CN)

(73) Assignee: SHENZHEN COOCAA NETWORK TECHNOLOGY CO,.LTD, Shenzhen (CN)

(21) Appl. No.: 14/357,833

(22) PCT Filed: Jan. 31, 2013
(86) PCT No.: PCT/CN2013/071186

§ 371 Date: May 13, 2014

(51) Int. Cl. H04N 21/431

(52) U.S. Cl. CPC H04N 21/4312

(57) ABSTRACT

The present invention relates to a field of household appliances and provides an interactive system and method for an intelligent television. The system includes a home page display device, a preview display device, and a list display device, wherein: a home page display device for displaying a category in a floating way and being linked to the preview display device and the list display device through a category link key linked to the at least one category; the preview display device for displaying brief information and pictures of the contents corresponding to the categories in a preview area in a floating way; a list display device for displaying the contents corresponding to the categories and time corresponding to the contents in a floating way. In the embodiments of the present invention, all pages are shown in the floating way, thereby, the users cannot be disturbed in the process of switching the program, and a page can be linked according to the category of the contents, thereby achieving the convenience of program switching.

### TECHNICAL FIELD

The present invention relates to a field of household appliances, and more particularly, to an interactive system and method for an intelligent television.

### BACKGROUND

Generally, during an existing application switching process, an existing intelligent television uses an interrupt to exit using application so as to jump to a desktop, and then finds a new application by a long distance jump to switch to the new application. If users are not satisfied with the new application, they can not return to the original application state. This switching way results in poor user experience, high cost for exploring new function, and long switching time, inconformity of using habits of the big-screen entertainment. Therefore, the problem of the prior art is bad entertainment coherence, poor user experience, and high cost for learning and operating the application.

### SUMMARY

The present invention provides an interactive system and a method for an intelligent television, all interactive operation are superimposed above the application in a floating way, so as to solve the problem of time interval exists between the audio or video contents when switching applications, incoherent user experience, long time and complex operations, and other issues in the process of switching applications. The present invention provides an interactive system for an intelligent television, the system includes a home page display device, a preview display device, and a list display device, wherein:

the home page display device is configured to display at least one category in a floating way and is linked to the preview display device and the list display device through a category link key linked to the at least one category.

the preview display device is configured to display brief information and pictures of the contents corresponding to the category in a preview area in a floating way.

the list display device is configured to display a list for displaying contents corresponding to the category and time corresponding to the contents in a floating way.

the present invention also provides an interactive method for an intelligent television, the method includes:

displaying at least one category in a floating way and linking to a preview display device and a list display device through a category link key inked to the at least one category;

displaying brief information and pictures of the contents corresponding to the category in a preview area of the preview display device in a floating way;

displaying the contents corresponding to the category and the time corresponding to the contents through a list of the list display device in a floating way.

From the above technical solution we can see that other tasks can be performed without interrupting a current application by way of displaying the window in a floating way. The home page shows all categories, operation switching of various functions is achieved by a category link key linked to the category, so the interactive operations become convenient. Embodiments of the present invention over the prior art, the user experience is greatly improved.

### BRIEF DESCRIPTION OF THE DRAWINGS

In order to more clearly illustrate the technical solutions of the present embodiment of the invention, drawings used in the embodiments or the prior art will be described briefly, it is obvious, the following descriptions of the drawings of the present invention are merely some embodiments, the skilled person can also obtain other drawings according to these drawings without creative efforts.

FIG. 1 shows a configuration diagram of an interactive system for an intelligent television in accordance with an embodiment of the present invention;

FIG. 2 shows a schematic view of a first page of a home page displayed on a home page display device in accordance with another embodiment of the present invention;

FIG. 3 shows a schematic view of a second page of the home page displayed on the home page display device in accordance with another embodiment of the present invention;

FIG. 4 shows a schematic view of a third page of the home page displayed on the home page display device in accordance with another embodiment of the present invention;

FIG. 5 shows a schematic view of a page corresponding to a preview display device in accordance with another embodiment of the present invention;

FIG. 6 shows a schematic view of a page corresponding to a list display device in accordance with another embodiment of the present invention;

FIG. 7 shows a schematic view of a page corresponding to a search display device in accordance with another embodiment of the present invention;

FIG. 8 shows a schematic view of a page corresponding to a status bar control device and a status bar push device in accordance with another embodiment of the present invention;

FIG. 9 shows a schematic view of a remote controller in accordance with another embodiment of the present invention;

FIG. 10 shows a schematic view of a page displayed on a detail information display unit in accordance with another embodiment of the present invention;

FIG. 11 shows a schematic view of a page displayed by a screening unit in accordance with another embodiment of the present invention;

FIG. 12 shows a flow chart of a display method for an intelligent television in accordance with another embodiment of the present invention.

### DETAILED DESCRIPTION OF THE PREFERRED EMBODIMENTS

In order to make the intention, technology solution, and advantages of the present invention more clearly, the detailed description to the present invention will be explained below in detail with reference to the accompanying drawings. It is to be appreciated that the following description of the embodiment(s) is merely to explain the present invention and is no way intended to limit the invention.

The realization of the invention will be explained in detail with embodiments described below:

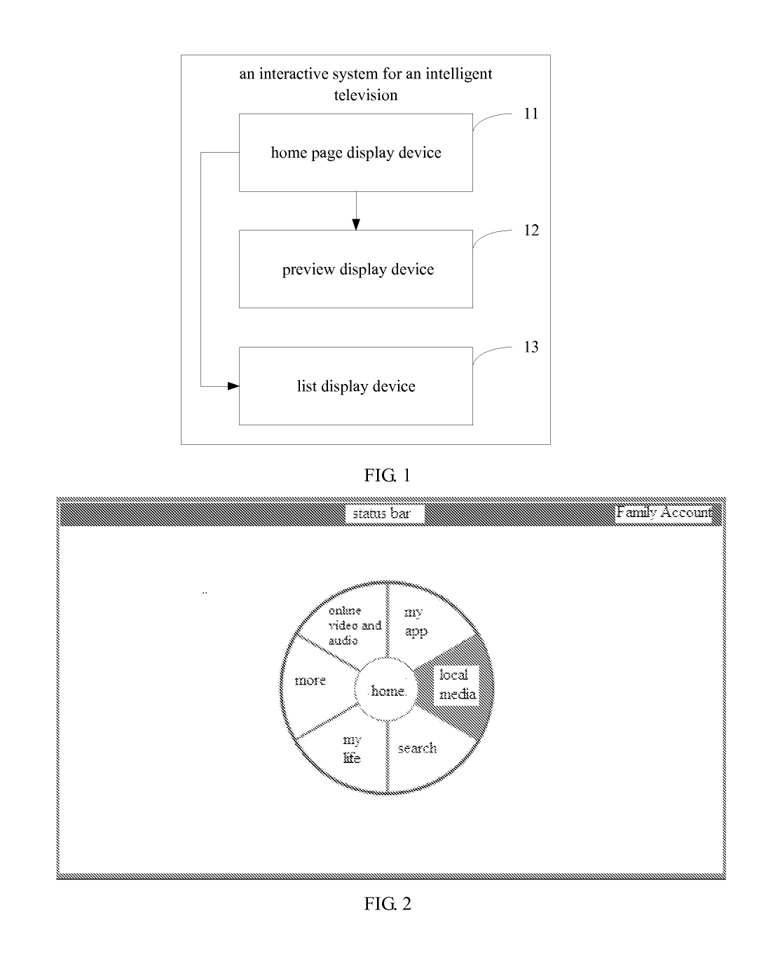

FIG. 1 shows a configuration diagram of an interactive system for an intelligent television in accordance with an embodiment of the present invention, for convenience of description, only portions related to the embodiment of the present invention are shown.

A home page display device 11 is used to display at least one category in a floating way, and is linked to a preview display device 12 and a list display device 13 through a category link key (not shown) linked to the at least one category, that is each category is linked to a category link key.

It should be noted that the floating display way of the category provides a multi-windows overlaying mode through which users can not only see contents of a currently using application, but also can operate other applications, thereby achieving a coherence entertainment and greatly improving user experience. Further, a unified entrance and a unified interactive way are adopted to reduce the operation learning costs of the users and be more in line with the entertainment function of the television. It should be noted that in the definition of a first page, a second page and a third page, the first page of the home page and the “more” enters the same ring of the home page. “online video and radio” of the home page is clicked to enter the ring, which is a sub level of the home page, with such as “movie and TV-play”, “new TV-play”.

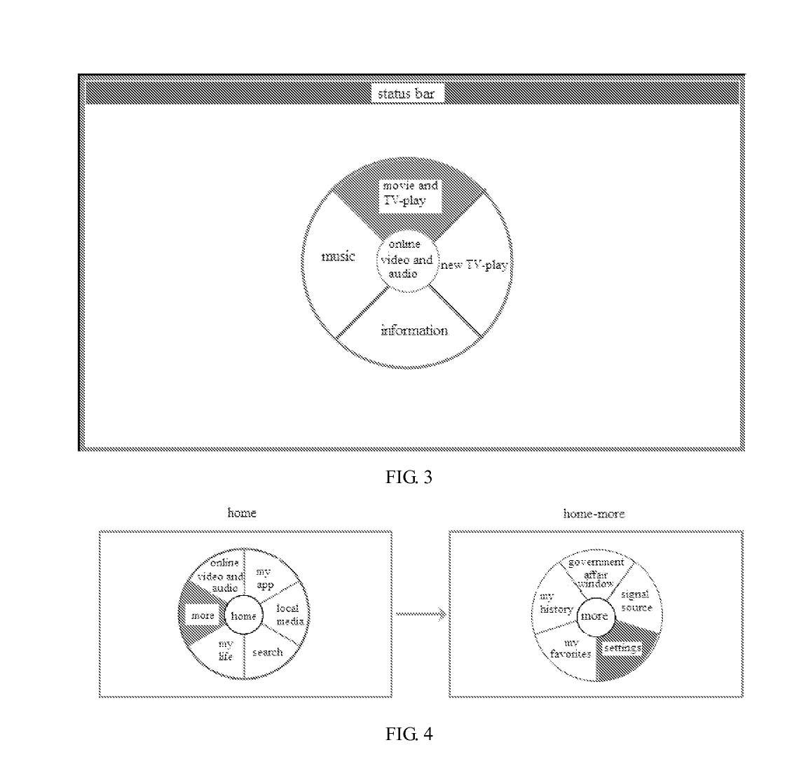

In this embodiment, the categories displayed by the home page display device are displayed on 3 pages, namely a first page, a second page, and a third page, of the home page, and each category is configured as a link key. As shown in FIG. 2, the categories displayed on the first page of the home page includes “online video and audio”, “my app”, “local media”, “search”, “my life”, “more”, wherein the “local media” and “my applications” can be linked to the preview display device 12. The categories of the first page have link relationships with other pages. For example, the first page of the home page can be linked to the second page of the home through the “online video and audio” link key. As shown in FIG. 3, the second page is used to display categories, such as “movie and TV-play”, “information”, “music”, and the like. The categories of the second page are mainly used to further classify the each category of the first page thereby the second page of the home page can be linked to the preview display device 13 through these link keys. Further, the first page of the home page can be linked to the third page of the home page through the “more” link key. As shown in FIG. 4, the categories of the third page includes “my history”, “government affair window”, “signal source”, “settings” and “my favorites”. The third page of the home page can be linked to the list display device 13 through “my history” link key. The home page display device 11 not only can be linked to the preview display device 12 and the list of device 13, but also can be linked to the other display devices referred in the embodiment of the present invention. The home page display device 11 is a unified entrance for accessing other devices.

The preview display device 12 is configured to display brief information and pictures of contents corresponding to the categories in a preview area (not shown) in a floating way.

In the present embodiments, the categories displayed by the preview display device 12 mainly include “movie and TV-play”, “music”, “picture” and “my applications”, and the like, which can allow the users directly access briefly information of all the categories, such as the “movie and TV-play”, “music”, “picture” and “my applications”.

The list display device 13 is used to display contents corresponding to the category and time corresponding to the contents in a floating way.

In the present embodiments, the categories displayed by the list display device 13 mainly include an application using history and using time corresponding to application in “my history”. The list display device 13 also supports multi-level display mode.

Preferably, the interactive system for an intelligent television also includes: a search display device (not shown) being used to display a search bar in a floating way and search results corresponding to search keywords.

It should be noted that the search display device is optional, the home page display device must have a link key linking to the search display device if there is a search display device.

In the present embodiments, the search display device receives characters or letters to determine keywords from association words of the characters or letters and further implements search according to the determined keywords. The search results are returned and displayed in the form of the category of the keywords and the number of search results corresponding to the keywords.

Preferably, the home page display device 11 can also be linked to the search display device according to a link key of a category “search” predefined on the home page display device.

Preferably, the interactive system for an intelligent television also includes:

a home page hidden device (not shown) is used to hide the home page when the home page display device does not receive any operation commands within a preset time interval.

It should be noted that the home page hidden device can only control the home page display device and can not have any impact on other devices. The displaying home page is hidden when not receiving any operation for a predetermine time.

Preferably, the interactive system for an intelligent television also includes:

a status bar control device being configured to pop up a status bar when the intelligent television receives a command to call the home page, hide the status bar when the intelligent television receives a full-screen command, close the status bar when the intelligent television receives a command to close the home, and further display a path of a current page, a message notification, a status of the intelligent television, and a music title of background music.

It should be noted that the path of the page identifies all path from the home page to the current page, the message notification includes a weather message, a time message, and a status of software download, and the like, and the status of the intelligent television expresses the status change of the equipment connected with the intelligent television.

Preferably, the interactive system for an intelligent television also includes:

a push device being used to show push information pushed from the background and types and amount of the information of the application state change in any display window, receive the viewing command for viewing the push information and the information of the application state change, and display the more detailed information of the push information and information of the application state change on the display window according to the viewing command.

Alternatively, the preview display device 13 further includes:

a detailed information display unit being configured to keep a focus retained on a picture in the preview area for a preset time and display detail information of the contents corresponding to the preview picture in the preview detail information display area.

a screening unit being configured to call screening options and search contents satisfying the condition defined by the screening options.

FIG. 5 shows a schematic view of a page displayed by a preview display device 12 in accordance with another embodiment of the present invention. Specifically, the page displayed by a preview display device 12 is linked by the “music” link key on the second page of the home page, and displays a picture of the music list brief information corresponding to the “music” link key.

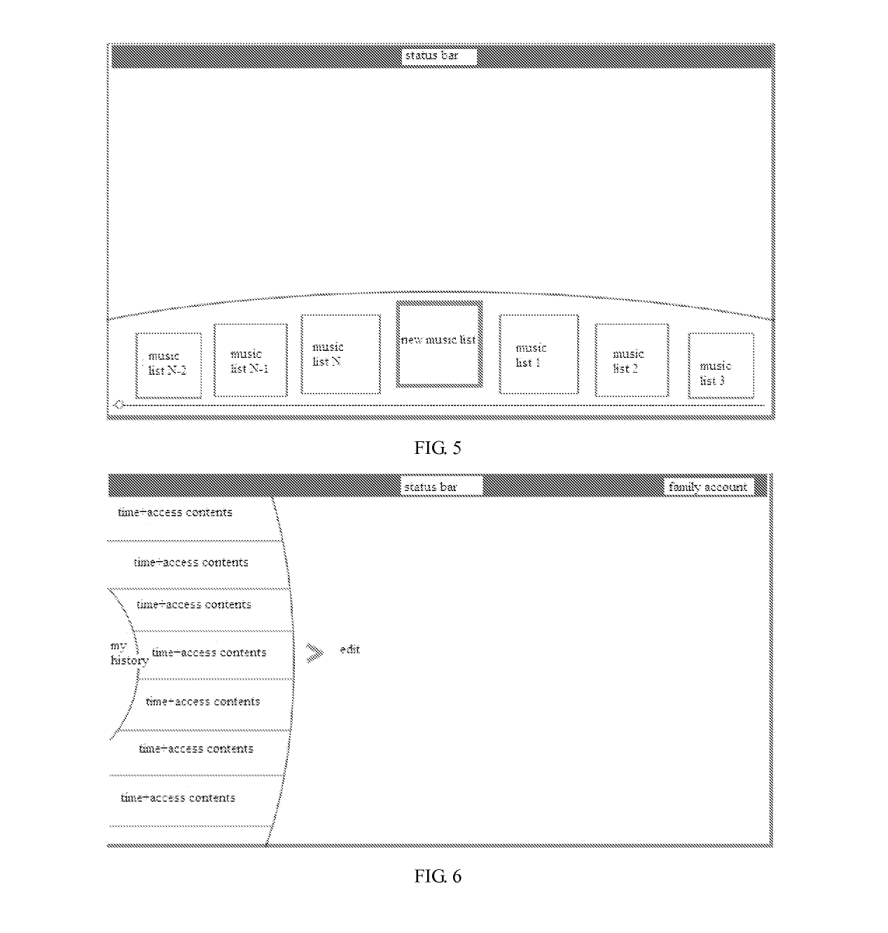

FIG. 6 shows a schematic view of a page displayed by the list display device 13 in accordance with another embodiment of the present invention. Specifically, the page displayed by the list display device 13 is linked by the “my history” link key on the third page of the home page and displays the history accessed contents and the access time of the accessed contents.

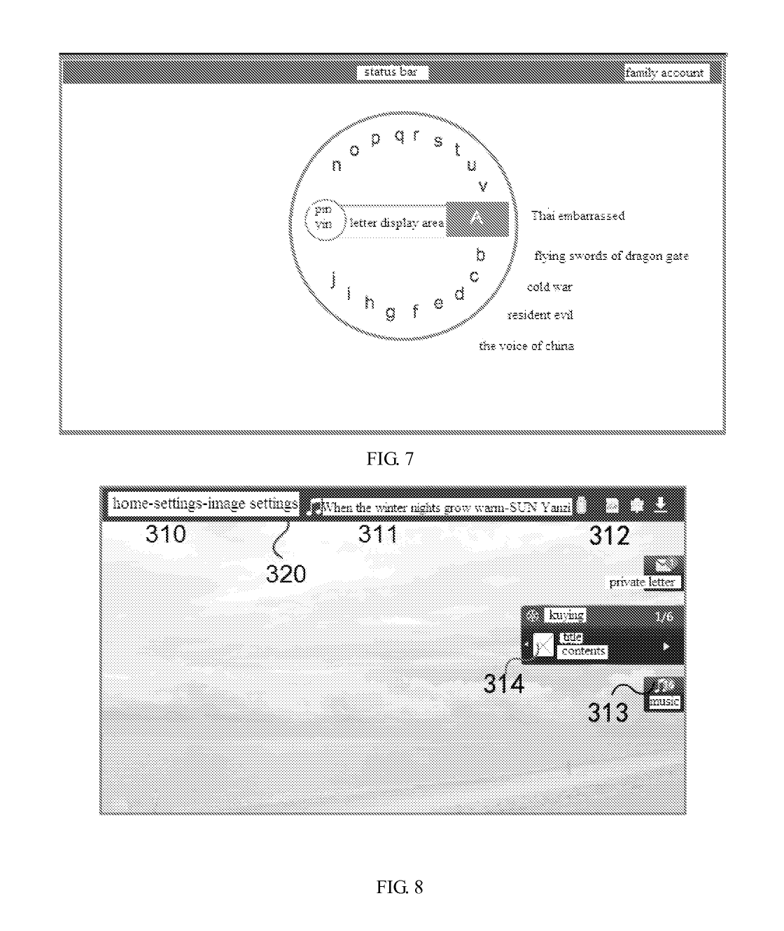

FIG. 7 shows a schematic view of a page displayed by a search display device in accordance with another embodiment of the present invention specifically, the search display device displays a ring searcher for receiving characters or letters, the keywords are determined from association words of the characters or letters. The search results are a collection which includes the category of the keywords and the number of search results corresponding to the keywords.

FIG. 8 shows a schematic view of a page displayed by a status bar control device and a push device in accordance with another embodiment of the present invention.

Specifically, a first area 313 shows the types and amount of the push information, a second area 314 is an example of viewing the detail of the push information by long time pressing a menu, a shuttle key, a direction key, a voice key, or a mouse; a third area 310 displays the path of the current page, which indicates that the current page is “settings” page and is linked from the home page, the “settings” page can be linked to the “image settings” page, a fourth area 311 displays the music information played by the background, the area 312 displays the state changing information of the intelligent television.

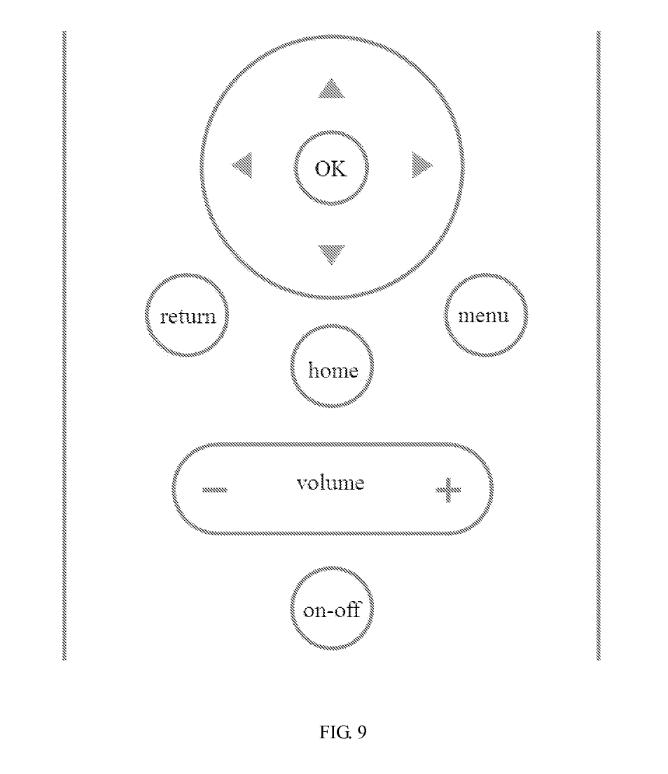

It should be noted that the shuttle is a tool as shown in FIG. 9 and is used to remotely control the intelligent television, the large ring around the OK key can be rotated in clockwise way or in counterclockwise way to select, switch, or moving up and down the icons.

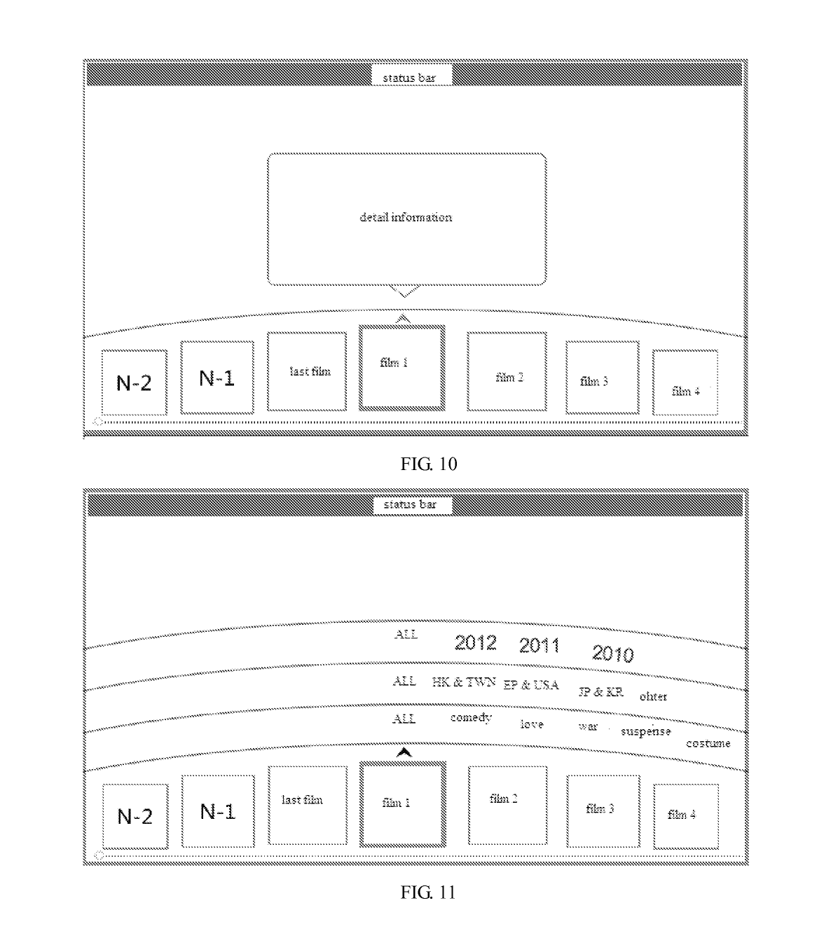

FIG. 10 shows a schematic diagram of a page displayed by a detail information display unit in accordance with another embodiment of the present invention.

### Specifically,

a focus is retained on a picture corresponding to a film 1 in the preview area, and the detail information of the film 1 is displayed in the preview detail information display area when the retain time of the focus reaches to 1.5-2 s.

FIG. 11 shows a schematic diagram of a page displayed by a screening unit in accordance with another embodiment of the present invention. Specifically, the screening options include options of time, area, and type of a movie, a required film is selected from the preview area according to the screening options. Only an embodiment for screening unit is shown here, but different screening options of the screening unit can be used for different embodiments.

In the present invention, all pages are shown in the floating way, thereby, the users cannot be disturbed in the process of switching the program, and a page can be linked according to the category of the contents, thereby achieving the convenience of program switching and solving the problem of disturbing users in the process of switching program and unclear category of the known technology, therefore, the user experience is greatly improved.

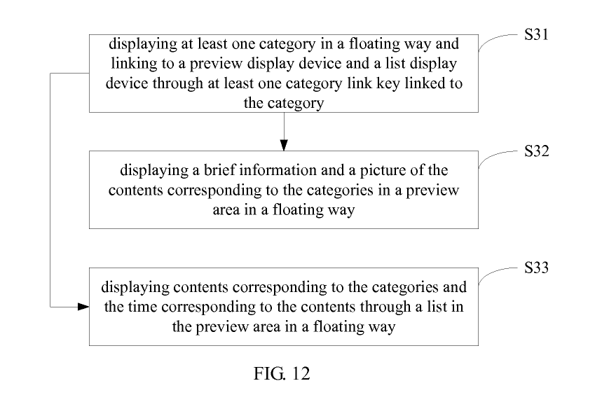

FIG. 12 shows a flow chart of a display method for an intelligent television in accordance with another embodiment of the present invention. The method includes:

S31, displaying at least one category in a floating way and linking to a preview display device and a list display device through at least one category link key linked to the category.

S32, displaying a brief information and a picture of the contents corresponding to the categories in a preview area in a floating way.

S33, displaying contents corresponding to the categories and the time corresponding to the contents through a list in the preview area in a floating way.

Alternatively, the method further includes:

displaying a search bar in the floating way and then searching contents corresponding to a search keyword inputted in the search bar.

Alternatively the method further includes:

linking to the search display device according to the search category link key.

Alternatively, the method further includes:

hiding the home page being displayed when a home page display device does not receive any operation command within a preset time interval.

Alternatively, the method further includes:

popping up a status bar when an intelligent television receives a command to call the home page, hiding the status bar when receiving a command of playing a music, a movie, or a picture, closing the status bar after receiving a command to close the home page, and displaying a path of a current page, a status of the intelligent television, and a title of the music played background on the status bar.

Alternatively, the method further includes:

showing push information pushed by the background and types and amount of information of the application state change in any display window, receiving the viewing command about the push information and the information of the application state change, and displaying the push information and the more detail information of the application state change on the display window according to the command.

Alternatively, after the step of S32, the method further includes:

keeping a focus retained on the picture in the preview area for a preset time and displaying detail information of the contents corresponding to a preview picture in the predefined detail information display area.

calling the screening options and searching contents satisfying the screening conditions defined by the screening options.

The skilled in the field can understand that the units and modules included in the above-described embodiments are divided according to the logical function, but they are not limited to the above division, any divisions that can achieve the corresponding function are includes in the scope of the present invention. Additional, the specific names of the functional units and the modules are only to facilitate users to distinguish the units and modules, but not intend to limit the scope of the invention.

As the skilled in the field can understand that all or part of the steps of the above-described embodiment of the method can be completed by controlling the relevant hardware by a program, the program can be stored in a computer readable storage medium, the storage medium, such as ROM/RAM, disk ,CD-ROM and so on.

The above-mentioned description is only a preferred embodiment of the present invention, which is not therefore limit the scope of the present invention. Any equivalent structures, or equivalent processes transform or the direct or indirect use in other related technical fields made by the specification and the figures of the present invention are similarly included within the scope of the present invention.

What is claimed is:

1. an interactive system for an intelligent television comprising a home page display device, a preview display device, and a list display device, wherein
the home page display device is configured to display at least one category in a floating way and is linked to the preview display device and the list display device through a category link key linked to the at least one category;
the preview display device is configured to display brief information and pictures of contents corresponding to the categories in a preview area in a floating way;
the list display device, is configured to display a list for displaying contents corresponding to the category and time corresponding to the contents in a floating way.

2. the interactive system for an intelligent television as claimed in claim 1, wherein the preview display device further comprising:
a detail information display unit being configured to keep a focus retained on a picture to be reviewed in the preview area for preset time, and detail information of the contents corresponding to the to be previewed picture is displayed in a detail information display area;
a screening unit being configured to call screening options and search contents satisfying the conditions defined by the screening options.

3. the interactive system for an intelligent television as claimed in claim 1, further comprising:
a search display device being configured to display a search bar in a floating way and search contents corresponding to search keywords inputted in the search bar;
a home page hidden device being configured to hide a home page being displayed when the home page display device does not receive any command within a preset time interval;
a status bar control device being configured to pop up a status bar when an intelligent television receives a command to call the home page, and hide the status bar when receiving a command of playing a music, a movie, and a picture, close the status bar after receiving a command to close the home page, and display a path of a current page, a message notification, a status of the intelligent television and a title of the music played background;
a push device being configured to show push information pushed by the background and types and amount of the information of the application state change in any display window, receive a viewing command about the push information and the information of the application state change, and display the push information and the more detail information of the application state change on the display window according to the viewing command.

4. the interactive system for an intelligent television as claimed in claim 3, wherein the home page display device is further configured to link to the search display device according to a search category link key linked to a search category.

5. an display method for an intelligent television comprising:
displaying at least one category in a floating way and linking to a preview display device and a list display device through a category link key linked to the at least one category;
displaying brief information and pictures of contents corresponding to the categories in a preview area of the preview display device in a floating way;
displaying contents corresponding to the category and the time corresponding to the contents through a list of the list display device in a floating way.

6. the display method as claimed in claim 5, wherein the method comprising:
linking to a search display device according to a search category link key linked to a search category;
hiding a home page being displayed when a home page display device does not receive any operation command within a preset time interval;
popping up a status bar when an intelligent television receives a command to call the home page, hiding the status bar when receives a command of playing a music, a movie, or a picture, closing the status bar after receiving a command to close the home page, and displaying a path of a current page, a status of the intelligent television, and a title of the music played background;
showing push information pushed by the background and types and amount of information of the application state change in any display window, receiving a viewing command about the push information and the information of the application state change, and displaying the push information and the more detail information of the application state change on the display window according to the viewing command.

7. the display method as claimed in claim 6, wherein after the step of displaying brief information and a picture of the contents corresponding to the categories in the preview area in a floating way, the method further comprising:
keeping a focus retained on a picture to be previewed in a preview area for a preset time and displaying detail information of the contents corresponding to the to be previewed picture in a preview detail information display area;
calling screening options and searching contents satisfying conditions defined by the screening options.
